(19) United States
(12) Patent Application Publication
(10) Pub. No.: US 2026/0066749 A1
(43) Pub. Date: Mar. 5, 2026

(54) ELECTRIC EQUIPMENT

(71) Applicant: HONDA MOTOR CO., LTD., Tokyo (JP)

(72) Inventors: Yoshihisa Kubota, Wako-shi (JP); Somei Nakatomi, Wako-shi (JP); Keisuke Azusawa, Wako-shi (JP)

(21) Appl. No.: 19/243,813

(22) Filed: Jun. 20, 2025

(30) Foreign Application Priority Data
Aug. 28, 2024 (JP) 2024-146341

(51) Int. Cl. H02K 11/33; H02K 1/16; H02K 3/12

(52) U.S. Cl. CPC H02K 11/33; H02K 1/16; H02K 3/12

(57) ABSTRACT

An electric equipment includes a power storage device, a rotating electric machine, and an electric power control unit. The electric power control unit includes a third full-bridge circuit connected to both ends of a β-phase-specific first coil of a rotating electric machine and a fourth full-bridge circuit connected to both ends of a β-phase-specific second coil. The β-phase-specific first coil and the β-phase-specific second coil form an alternating current (AC) input phase connected to an AC power supply connection member. The rotating electric machine includes a stator core having slots in which the first coil and the second coil having a different combination of the number of turns in a first pole and a second pole forming a pole pair are arranged.

### CROSS-REFERENCE TO RELATED APPLICATION

Priority is claimed on Japanese Patent Application No. 2024-146341, filed Aug. 28, 2024, the content of which is incorporated herein by reference.

### BACKGROUND

### Field of the Invention

The present invention relates to electric equipment.

### Description of Related Art

In recent years, research and development (R&D) related to electricity charging and supply using mobilities equipped with secondary batteries that contribute to energy efficiency has been conducted to ensure that more people have access to affordable, reliable, sustainable, and advanced energy.

Conventionally, for example, an electric vehicle that converts alternating current (AC) power supplied from an external power supply into direct current (DC) power by combining a multi-phase stator winding of a motor with a multi-phase bridge circuit using switching elements is known (see, for example, the following Patent Document 1). In this electric vehicle, a control process of setting a rotor position (a rotation angle) to a predetermined position when the motor is stopped is performed to suppress the generation of torque in the motor during AC charging from the external power supply and to maximize inductance.

Moreover, conventionally, a motor in which the number of turns of two windings connected in series on each of N and S poles that are stator-specific magnetic poles is set to be the same is known (see, for example, the following Patent Document 2).

[Patent Document 1] Japanese Unexamined Patent Application, First Publication No. 2009-65808

[Patent Document 2] Japanese Unexamined Patent Application, First Publication No. 2020-25377

### SUMMARY

In technology for charging and discharging a mobility equipped with a secondary battery, an issue is to suppress the occurrence of gear impact noise that is so-called backlash noise, caused by the torque generated by the motor during AC charging from an external power supply, while suppressing a decrease in charging efficiency due to an increase in electric current distortion or the like. For example, when a control process is performed so that the rotor position is set to a predetermined position when the motor is stopped in advance, as in the electric vehicle of the above-described conventional technology, it may be difficult to properly control the rotor position due to a driver's intention, the surrounding environment, other in-vehicle controls, or the like. Moreover, even if the rotor position is set to the predetermined position, the rotor vibrates in accordance with a frequency of the charging current during AC charging and this may cause backlash noise of a gear connected to the rotor.

The present invention has been made in view of the above circumstances and an objective of the present invention is to provide electric equipment that can suppress the generation of impact noise and the decrease in charging efficiency caused by rotor vibration during AC charging. Also, the present invention contributes to energy efficiency.

In order to solve the above problems and achieve the above objective, the present invention employs the following aspects.

(1): According to an aspect of the present invention, there is provided electric equipment including: a power storage device; a rotating electric machine having a rotor and a plurality of coils; an electric power control unit connected to the rotating electric machine and the power storage device and configured to control electric power transmission and reception of each of the power storage device and the rotating electric machine; and an alternating current (AC) power supply connection member configured to connect the rotating electric machine and an external AC power supply, wherein the electric power control unit includes a first full-bridge circuit connected to both ends of a first coil and a second full-bridge circuit connected to both ends of a second coil with respect to the first coil and the second coil forming a predetermined phase connected to the AC power supply connection member among the plurality of coils, and wherein the rotating electric machine includes a stator core having slots in which the first coil and the second coil having a different combination of the number of turns in a first pole and a second pole forming a pole pair are arranged.

(2): In the above-described aspect (1), the first coil and the second coil may be arranged in the slots facing each other in a state in which a central axis is sandwiched therebetween in the stator core.

(3): In the above-described aspect (2), the first coil and the second coil may be arranged in a first slot and a second slot, respectively, with respect to the first slot and the second slot that are the slots facing each other in the state in which the central axis is sandwiched therebetween in the stator core.

(4): In any one of the above-described aspects (1) to (3), a combination of the number of turns of the first coil and the second coil in the first pole and the second pole may be identical for all pole pairs of the stator core.

(5): In the above-described aspect (4), the predetermined phase may be an AC input phase for converting an input of AC power into an output of direct current (DC) power.

(6): In the above-described aspect (5), the electric power control unit may include a first disconnector connected between an end of the first coil and the first full-bridge circuit; a second disconnector connected between an end of the second coil and the second full-bridge circuit; a third full-bridge circuit connected to both ends of a third coil and a fourth full-bridge circuit connected to both ends of a fourth coil with respect to the third coil and the fourth coil forming a DC conversion phase for performing conversion between DC powers among the plurality of coils; a third disconnector connected between positive poles of the third full-bridge circuit and the fourth full-bridge circuit; and a fourth disconnector connected between negative poles of the third full-bridge circuit and the fourth full-bridge circuit.

According to the above-described aspect (1), the combination of the number of turns of the first coil and the second coil connected to the external AC power supply is different for the first pole and the second pole forming the pole pair in the stator core, such that mutual cancellation of magnetic fluxes is suppressed, for example, even if a current-carrying process is performed in an inverted phase during a parallel connection. An inductance larger than the leakage inductance can be generated and the charging efficiency can be improved by suppressing ripples and distortions in the electric current.

In the case of the above-described aspect (2), the first coil and the second coil are arranged in slots facing each other across the central axis of the stator core, such that even if a current-carrying process is performed in an inverted phase during parallel connection, for example, a magnetic flux distribution that cancels out the torque on the rotor can be generated. By suppressing the torque generation of the rotating electric machine during AC charging, the generation of impact noise such as gear backlash noise caused by torque pulsation can be suppressed.

In the case of the above-described aspect (3), by placing the first coil in the first slot and placing the second coil in the second slot, the inductance can be increased and electric current ripples, distortion, or the like can be further suppressed.

In the case of the above-described aspect (4), for example, the number of turns of the first coil and the second coil can be made the same for the entire stator core according to a corresponding relationship in which the combination of the number of turns of each coil on the first pole and the second pole is inverted or the like. Thereby, it is possible to suppress the generation of torque of the rotating electric machine during AC charging and to cause the back electromotive waveform of each coil when the rotating electric machine is driven to be the same as that when the number of turns of the first coil and the second coil in each of the first pole and the second pole is the same.

In the case of the above-described aspect (5), the charging efficiency can be improved by suppressing electric current ripples, distortion, and the like while suppressing the generation of impact noise such as gear backlash noise caused by torque pulsation of the rotating electric machine during AC charging.

In the case of the above-described aspect (6), when the rotating electric machine is driven by the power storage device, the power control unit can function as an inverter of a multi-level full-bridge circuit. When the power storage device is charged with AC power by an external AC power supply, a combination of the third coil and the fourth coil and the third full-bridge circuit and the fourth full-bridge circuit can function as an insulated bidirectional DC-DC converter. For example, in the case of a boost operation during AC charging, rapid charging can be performed with respect to the voltage of the power storage device that is higher than the charging voltage of the external AC power supply.

### BRIEF DESCRIPTION OF THE DRAWINGS

FIG. 1 is a diagram showing a configuration of electric equipment according to an embodiment of the present invention.

FIG. 2 is a modeled configuration diagram of each full-bridge circuit and a rotating electric machine in the electric equipment according to the embodiment of the present invention.

FIG. 3 is a block diagram showing the functional configuration of an electronic control unit during AC charging in the electric equipment according to the embodiment of the present invention.

FIG. 4 is a circuit diagram showing an example of a current flow in a parallel mode during AC charging in the electric equipment according to the embodiment of the present invention.

FIG. 5 is a modeled configuration diagram of a rotating electric machine according to a first modified example of the embodiment of the present invention.

FIG. 6 is a modeled configuration diagram of a rotating electric machine according to a second modified example of the embodiment of the present invention.

FIG. 7 is a modeled configuration diagram of a rotating electric machine according to a third modified example of the embodiment of the present invention.

FIG. 8 is a configuration diagram showing an example of distributed winding of the rotating electric machine according to the third modified example of the embodiment of the present invention.

### DETAILED DESCRIPTION OF THE INVENTION

Hereinafter, electric equipment according to an embodiment of the present invention will be described with reference to the accompanying drawings.

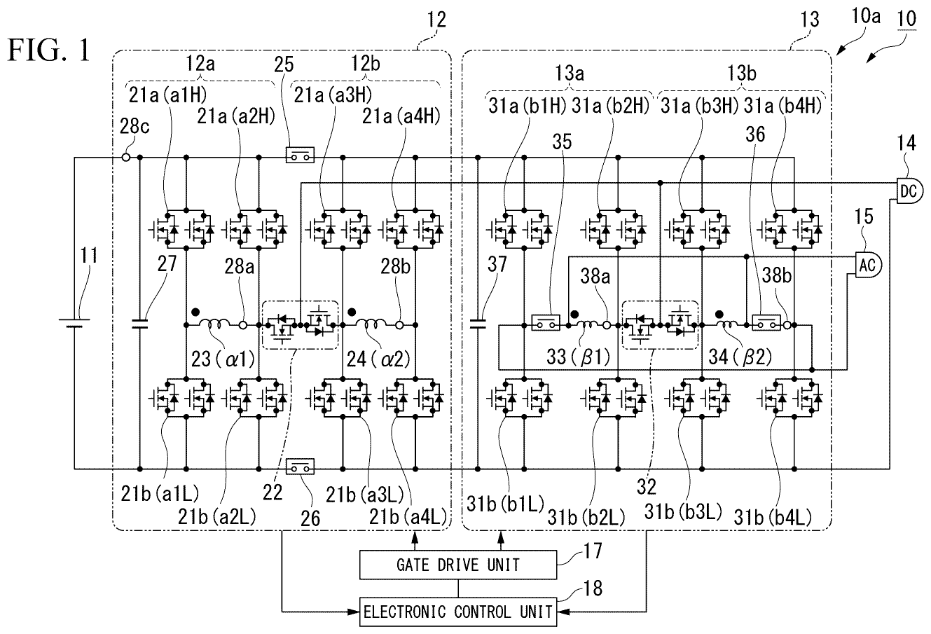

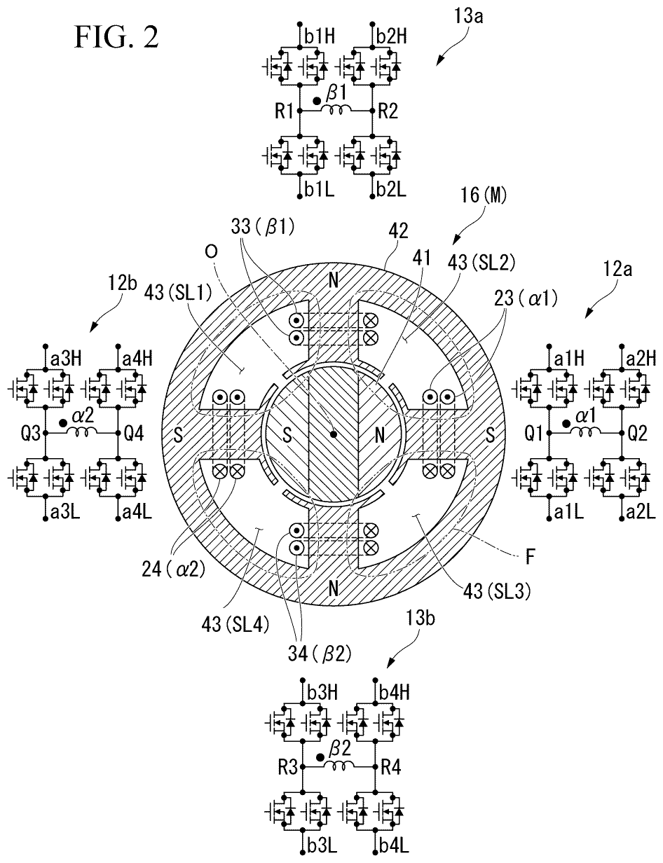

FIG. 1 is a diagram showing a configuration of electric equipment 10 according to the embodiment. FIG. 2 is a diagram showing a modeled configuration of each of full-bridge circuits 12a, 12b, 13a, and 13b and a rotating electric machine 16 in the electric equipment 10 according to the embodiment.

The electric equipment 10 of the embodiment is mounted on, for example, an electric vehicle, an electric mobile object, an electric machine, a power supply device, or the like. The electric vehicle is, for example, an electric car equipped with a rotating electric machine as a power supply, a saddle-type vehicle, a kick scooter, a hybrid vehicle based on a combination of a rotating electric machine and an internal combustion engine, a fuel cell vehicle based on a combination of a power storage device and a fuel cell, or the like. The electric mobile object is, for example, a robot, an aircraft, and a mobile object on or under water and the like. The electric machine is, for example, a construction machine equipped with a rotating electric machine as a power supply or the like. The power supply device is, for example, a stationary or mobile power supply device that discharges and charges a power storage device or the like.

### (Electric Equipment)

As shown in FIGS. 1 and 2, electrical equipment 10 of the embodiment includes, for example, a power storage device 11, a first power conversion unit 12, a second power conversion unit 13, a DC power supply connection unit 14, an AC power supply connection unit 15, a rotating electric machine 16 (M), a gate drive unit 17, and an electronic control unit 18. In addition, for example, the first power conversion unit 12, the second power conversion unit 13, the DC power supply connection unit 14, the AC power supply connection unit 15, the gate drive unit 17, and the electronic control unit 18 constitute a power control unit 10a.

The power storage device 11 is connected to the first power conversion unit 12 and the second power conversion unit 13, which will be described below.

The power storage device 11 includes, for example, a plurality of battery cells connected in series or parallel. Each battery cell is, for example, a secondary battery such as a lead acid battery, a lithium-ion battery, a nickel metal hydride battery, or an all-solid-state battery, a capacitor such as an electric double layer capacitor, or a composite battery based on a combination of a secondary battery and a capacitor. Each battery cell is repeatedly charged and discharged. The power storage device 11 exchanges electric power with the rotating electric machine 16 via the power control unit 10a. The power storage device 11 is charged by an external power supply (an external DC power supply and an external AC power supply).

The first power conversion unit 12 includes a first full-bridge circuit 12a and a second full-bridge circuit 12b.

Each of the first full-bridge circuit 12a and the second full-bridge circuit 12b includes a so-called H-bridge circuit formed by a plurality of switching elements that are bridge-connected in two phases. Each switching element is, for example, a transistor such as a metal oxide semiconductor field effect transistor (MOSFET) made of silicon carbide (SiC) or an insulated gate bipolar transistor (IGBT). Each switching element is, for example, an N-channel MOSFET.

The plurality of switching elements are, for example, pairs of transistors forming each of the element units 21a and 21b of a high-side arm and a low-side arm that are paired in each phase. The pair of transistors in each of the element units 21a and 21b are, for example, connected in parallel.

In addition, the full-bridge circuits 12a and 12b may include, for example, rectifying elements such as reflux diodes connected in parallel in a forward direction from an emitter to a collector between the collector and emitter of each transistor.

The first power conversion unit 12 includes, for example, a first switch 22 connected between midpoints Q2 and Q3 of the first full-bridge circuit 12a and the second full-bridge circuit 12b. The midpoint Q2 of the first full-bridge circuit 12a is, for example, a connection point between a high-side arm element unit 21a (a2H) and a low-side arm element unit 21b (a2L) that are connected in series in the second phase between the first and second phases that are the two phases of the first full-bridge circuit 12a. For example, the midpoint Q2 is a connection point between a source of the high-side arm element unit 21a (a2H) and a drain of the low-side arm element unit 21b (a2L). The midpoint Q3 of the second full-bridge circuit 12b is, for example, a connection point between a high-side arm element unit 21a (a3H) and a low-side arm element unit 21b (a3L) that are connected in series in the first phase between the first and second phases that are the two phases of the second full-bridge circuit 12b. For example, the midpoint Q3 is a connection point between a source of a high-side arm element unit 21a (a3H) and a drain of a low-side arm element unit 21b (a3L).

The first switch 22 is, for example, a bidirectional switch formed by two switching elements. Each switching element is a transistor such as a MOSFET or an IGBT and is, for example, an N-channel MOSFET. The first switch 22 includes, for example, two transistors connected in anti-series. The two transistors are connected in series in directions opposite each other, for example, by connecting their sources to each other. The first switch 22 switches the electric current between the midpoints Q2 and Q3 between an electrical connection and an electrical disconnection by turning on (electrical connection)/off (electrical disconnection) the two transistors.

In addition, each transistor may include a rectifying element, such as a reflux diode, connected in parallel in the forward direction from the emitter to the collector, between the collector and the emitter.

The first power conversion unit 12 is connected to an α-phase-specific first coil 23 (α1) and an α-phase-specific second coil 24 (α2) of the rotating electric machine 16 to be described below. The α-phase-specific first coil 23 is connected between midpoints Q1 and Q2 of the first full-bridge circuit 12a. The α-phase-specific second coil 24 (α2) is connected between midpoints Q3 and Q4 of the second full-bridge circuit 12b. The midpoint Q1 of the first full-bridge circuit 12a is, for example, a connection point between the high-side arm element unit 21a (a1H) and the low-side arm element unit 21b (a1L) that are connected in series in the first phase of the first full-bridge circuit 12a. For example, the midpoint Q1 is a connection point between the source of the high-side arm element unit 21a (a1H) and the drain of the low-side arm element unit 21b (a1L). The midpoint Q4 of the second full-bridge circuit 12b is, for example, a connection point between the high-side arm element unit 21a (a4H) and the low-side arm element unit 21b (a4L) that are connected in series in the second phase of the second full-bridge circuit 12b. For example, the midpoint Q4 is a connection point between the source of the high-side arm element unit 21a (a4H) and the drain of the low-side arm element unit 21b (a4L).

The first power conversion unit 12 includes a first disconnector 25 connected between the positive electrodes of the first full-bridge circuit 12a and the second full-bridge circuit 12b and a second disconnector 26 connected between the negative electrodes of the first full-bridge circuit 12a and the second full-bridge circuit 12b.

Each of the first disconnector 25 and the second disconnector 26 is, for example, a contactor, and switches the connection between the first full-bridge circuit 12a and the second full-bridge circuit 12b between ON (electrical connection) and OFF (electrical disconnection).

The first power conversion unit 12 includes, for example, a capacitor 27 connected between positive and negative electrodes. The capacitor 27, for example, smoothes voltage fluctuations that occur with a switching operation of each switching element of the first power conversion unit 12 between ON (electrical connection) and OFF (electrical disconnection).

The first power conversion unit 12 includes, for example, a first current sensor 28a arranged between an α-phase-specific first coil 23 (α1) and the midpoint Q2, a second current sensor 28b arranged between an α-phase-specific second coil 24 (α2) and the midpoint Q4, and a third current sensor 28c arranged between the power storage device 11 and the first power conversion unit 12.

For example, the first current sensor 28a detects the electric current flowing through the α-phase-specific first coil 23 (α1) and the second current sensor 28b detects the electric current flowing through the α-phase-specific second coil 24 (α2).

The third current sensor 28c detects the electric current flowing between the first power conversion unit 12 and the power storage device 11.

The second power conversion unit 13 includes a third full-bridge circuit 13a and a fourth full-bridge circuit 13b.

Each of the third full-bridge circuit 13a and the fourth full-bridge circuit 13b includes, for example, a so-called H-bridge circuit formed by a plurality of switching elements that are bridge-connected in two phases. Each switching element is, for example, a MOSFET such as SiC or a transistor such as an IGBT. Each switching element is, for example, an N-channel MOSFET.

The switching elements are, for example, pairs of transistors forming each of the high- and low-side arm element units 31a and 31b paired in each phase. The pair of transistors in the element units 31a and 31b are, for example, connected in parallel.

In addition, the full-bridge circuits 13a and 13b may include rectifying elements such as reflux diodes connected in parallel in the forward direction from the emitter to the collector between the collector and emitter of each transistor.

The second power conversion unit 13 includes, for example, a second switch 32 connected between midpoints R2 and R3 of the third full-bridge circuit 13a and the fourth full-bridge circuit 13b. The midpoint R2 of the third full-bridge circuit 13a is, for example, a connection point between the high-side arm element unit 31a (b2H) and the low-side arm element unit 31b (b2L) that are connected in series in the second phase between the first phase and the second phase that are the two phases of the third full-bridge circuit 13a. For example, the midpoint R2 is a connection point between the source of the high-side arm element unit 31a (b2H) and the drain of the low-side arm element unit 31b (b2L). The midpoint R3 of the fourth full-bridge circuit 13b is, for example, a connection point between the high-side arm element unit 31a (b3H) and the low-side arm element unit 31b (b3L) that are connected in series in the first phase between the first phase and the second phase that are the two phases of the fourth full-bridge circuit 13b. For example, the midpoint R3 is a connection point between the source of the high-side arm element unit 31a (b3H) and the drain of the low-side arm element unit 31b (b3L).

The second switch 32 is, for example, a bidirectional switch formed by two switching elements. Each switching element is a transistor such as a MOSFET or an IGBT, and is, for example, an N-channel MOSFET. The second switch 32 includes, for example, two transistors connected in anti-series. The two transistors, for example, are connected in series in directions opposite each other by connecting their sources to each other. The second switch 32 switches an electric current between the midpoints R2 and R3 between an electrical connection and an electrical disconnection by turning on (electrical connection)/off (electrical disconnection) the two transistors.

In addition, the respective transistors may include rectifying elements, such as reflux diodes, connected in parallel in the forward direction from the emitter to the collector, between the collector and the emitter.

The second power conversion unit 13 is connected to a β-phase-specific first coil 33 (β1) and a β-phase-specific second coil 34 (β2) of the rotating electric machine 16 to be described below. The β-phase-specific first coil 33 is connected between the midpoints R1 and R2 of the third full-bridge circuit 13a. The β-phase-specific second coil 34 (β2) is connected between midpoints R3 and R4 of the fourth full-bridge circuit 13b. The midpoint R1 of the third full-bridge circuit 13a is, for example, a connection point between the high-side arm element unit 31a (b1H) and the low-side arm element unit 31b (b1L) that are connected in series in the first phase of the third full-bridge circuit 13a. For example, the midpoint R1 is a connection point between the source of the high-side arm element unit 31a (b1H) and the drain of the low-side arm element unit 31b (b1L). The midpoint R4 of the fourth full-bridge circuit 13b is, for example, a connection point between the high-side arm element unit 31a (b4H) and the low-side arm element unit 31b (b4L) that are connected in series in the second phase of the fourth full-bridge circuit 13b. For example, the midpoint R4 is a connection point between the source of the high-side arm element unit 31a (b4H) and the drain of the low-side arm element unit 31b (b4L).

The second power conversion unit 13 includes a third disconnector 35 connected between one end of the β-phase-specific first coil 33 (β1) and the third full-bridge circuit 13a and a fourth disconnector 36 connected between one end of the β-phase-specific second coil 34 (β2) and the fourth full-bridge circuit 13b.

Each of the third disconnector 35 and the fourth disconnector 36 is, for example, a contactor. The third disconnector 35, for example, is connected between one end of the β-phase-specific first coil 33 (β1) and the midpoint R1 of the first phase of the third full-bridge circuit 13a and switches the connection between the β-phase-specific first coil 33 (β1) and the midpoint R1 between ON (electrical connection) and OFF (electrical disconnection). The fourth disconnector 36, for example, is connected between one end of the β-phase-specific second coil 34 (β2) and the midpoint R4 of the fourth phase of the fourth full-bridge circuit 13b and switches the connection between the β-phase-specific second coil 34 (β2) and the midpoint R4 between ON (electrical connection) and OFF (electrical disconnection).

The second power conversion unit 13 includes, for example, a capacitor (a condenser) 37 connected between a positive electrode and a negative electrode. The capacitor 37, for example, smoothes voltage fluctuations that occur with the switching operation of each switching element of the second power conversion unit 13 between ON (electrical connection) and OFF (electrical disconnection).

The second power conversion unit 13 includes, for example, a fourth current sensor 38a arranged between the β-phase-specific first coil 33 (β1) and the midpoint R2, and a fifth current sensor 38b arranged between the β-phase-specific second coil 34 (β2) and the midpoint R4.

For example, the fourth current sensor 38a detects the electric current flowing through the β-phase-specific first coil 33 (β1). The fifth current sensor 38b detects the electric current flowing through the β-phase-specific second coil 34 (β2).

The DC power supply connection unit 14 and the AC power supply connection unit 15 include, for example, connectors for DC power and AC power of a predetermined standard and the like. The DC power supply connection unit 14 and the AC power supply connection unit 15, for example, are connected to an external DC power supply and an external AC power supply based on a commercial power supply connected to a power system and the like.

The DC power supply connection unit 14, for example, is connected to the negative electrode of the second power conversion unit 13 and the midpoint of each of the first switch 22 and the second switch 32 (i.e., between the two transistors connected in anti-series).

The AC power supply connection unit 15, for example, is connected to each of the first midpoint R1 and the fourth midpoint R4 of the second power conversion unit 13 and each of the connection point between the β-phase-specific first coil 33 (β1) and the third disconnector 35 and the connection point between the β-phase-specific second coil 34 (β2) and the fourth disconnector 36.

The rotating electric machine 16 (M) is, for example, a two-phase brushless DC motor. The rotating electric machine 16 includes, for example, the α-phase-specific first coil 23 (α1), the α-phase-specific second coil 24 (α2), the β-phase-specific first coil 33 (β1), the β-phase-specific second coil 34 (β2), a rotor 41, and a stator core 42. The rotor 41 includes a permanent magnet for a field magnet. The stator core 42 has coils α1, α2, β1, and β2 mounted thereon to generate a rotating magnetic field that rotates the rotor 41.

The α-phase-specific first coil 23 (α1) and the α-phase-specific second coil 24 (α2) and the β-phase-specific first coil 33 (β1) and the β-phase-specific second coil 34 (β2) are so-called open-ended coils, and the ends of the respective coils α1, α2, β1, and β2 are not connected to each other (i.e., the respective coils α1, α2, β1, and β2 are disconnected from each other) and are pulled out of the rotating electric machine 16.

The α-phase-specific first coil 23 (α1) and the α-phase-specific second coil 24 (α2), for example, have a mutual spatial phase difference of zero and are wound around the teeth of the stator core 42 in the same direction when seen in an axial direction along the central axis O of the rotating electric machine 16 (M). The α-phase-specific first coil 23 (α1) and the α-phase-specific second coil 24 (α2), for example, are arranged to share or individually occupy a part of a slot 43 formed in the stator core 42 and are magnetically coupled to each other with the same polarity.

The β-phase-specific first coil 33 (β1) and the β-phase-specific second coil 34 (β2), for example, have a mutual spatial phase difference of zero, and are wound around the teeth of the stator core 42 in the same direction when seen in the axial direction along the central axis O of the rotating electric machine 16 (M). The β-phase-specific first coil 33 (β1) and the β-phase-specific second coil 34 (β2), for example, are arranged to share or individually occupy a part of the slot 43 formed in the stator core 42 and are magnetically coupled to each other with the same polarity.

The α-phase-specific first coil 23 (α1) and the α-phase-specific second coil 24 (α2) and the β-phase-specific first coil 33 (β1) and the β-phase-specific second coil 34 (β2) are arranged so that they do not magnetically interfere with each other by setting the spatial phase difference to 90°.

For example, the coils α1, α2, β1, and β2 are attached to the stator core 42 according to concentrated winding or distributed winding or the like.

Among the α-phase coils α1 and α2 and the β-phase coils β1 and β2, at least the β-phase coils β1 and β2 are arranged so that a combination of the number of turns is different between the first pole and the second pole forming a pole pair (N and S poles) in the stator core 42. The combination of the number of turns is, for example, a case where the first pole and the second pole each have the β-phase-specific first coil 33 (β1) and the β-phase-specific second coil 34 (β2) and a case where the number of turns of the β-phase-specific first coil 33 (β1) or the β-phase-specific second coil 34 (β2) is zero in each of the first pole and the second pole. When the first pole and the second pole each have the coils β1 and β2, a ratio of the number of turns of the coils β1 and β2 (a so-called relative ratio) is defined as a value other than 1. Cases where the number of turns is zero include, for example, a case where only the β-phase-specific first coil 33 (β1) is provided on the first pole and only the β-phase-specific second coil 34 (β2) is provided on the second pole and a case where only the β-phase-specific second coil 34 (β2) is provided on the first pole and only the β-phase-specific first coil 33 (β1) is provided on the second pole.

A corresponding relationship between the combination of the number of turns of the coils β1 and β2 on the first pole and the combination of the number of turns of the coils β1 and β2 on the second pole, for example, is a mutually inverted corresponding relationship, such as an inverse ratio of the number of turns of the coils β1 and β2. A corresponding relationship between the first pole and the second pole regarding the combination of the number of turns of the coils β1 and β2 is, for example, two mutually inverted corresponding relationships of the first pole pair and the second pole pair that are set alternately with each other in the same number of turns in a circumferential direction of the stator core 42.

The combination of the number of turns of each of the coils β1 and β2 is the same for the first pole and the second pole of all pole pairs of the stator core 42. For each of the first pole and the second pole of the entire stator core 42, the number of turns of the β-phase-specific first coil 33 (β1) and the number of turns of the β-phase-specific second coil 34 (β2) are the same.

The following Table 1 shows an example of the number of turns of each of the coils α1, α2, β1, and β2 corresponding to the N pole and the S pole in each of the first pole pair and the second pole pair in the rotating electric machine 16 (M) of the embodiment shown in FIG. 2. As shown in the following Table 1, in each of the first pole pair and the second pole pair, the corresponding relationship between the combination of the number of turns of the coils β1 and β2 on the N pole and the combination of the number of turns of the coils β1 and β2 on the S pole is mutually inverted. In relation to the combination of the number of turns of each of the coils β1 and β2, the corresponding relationship between the N pole and the S pole in the first pole pair and the corresponding relationship between the N pole and the S pole in the second pole pair are mutually inverted.

As shown in the following Table 1, in the rotating electric machine 16 (M) of the embodiment shown in FIG. 2, like the respective coils β1 and β2 of the β phase, the respective coils α1 and α2 of the α phase are arranged so that the combinations of the number of turns are different for the first pole and the second pole forming a pole pair (N and S poles) in the stator core 42.

TABLE 1

| Magnetic pole | |
|---|---|
| First pole pair | Second pole pair |

| Coil | N pole | S pole | N pole | S pole |
|---|---|---|---|---|
| α1 | 0 | 32 | 32 | 0 |
| α2 | 32 | 0 | 0 | 32 |
| β1 | 0 | 32 | 32 | 0 |
| β2 | 32 | 0 | 0 | 32 |

For example, in the rotating electric machine 16 (M) of the embodiment shown in FIG. 2, the β-phase-specific first coil 33 (β1) is arranged in a first slot SL1 and a second slot SL2 and the β-phase-specific second coil 34 (β2) is arranged in a third slot SL3 and a fourth slot SL4, with respect to the slots 43 of the stator core 42 facing each other (the first slot SL1 and the second slot SL2 facing the third slot SL3 and the fourth slot SL4) in a state in which the central axis O is sandwiched therebetween. Moreover, in the α-phase, as in the β-phase, the α-phase-specific first coil 23 (α1) is arranged in the second slot SL2 and the third slot SL3, and the α-phase-specific second coil 24 (α2) is arranged in the first slot SL1 and the fourth slot SL4, with respect to the slots 43 of the stator core 42 that face each other (the second slot SL2 and the third slot SL3 facing the first slot SL1 and the fourth slot SL4) in a state in which the central axis O is sandwiched therebetween.

The rotating electric machine 16 (M) generates rotational motive power by performing a power running operation using electric power supplied from the first power conversion unit 12 and the second power conversion unit 13. For example, when the rotating electric machine 16 (M) is connected to the wheels of a vehicle, a driving force for running is generated using electric power supplied from the first power conversion unit 12 and the second power conversion unit 13. The rotating electric machine 16 (M) may generate power by performing a regenerative operation using rotational motive power input from a wheel side of the vehicle. For example, when the rotating electric machine 16 (M) is connected to an internal combustion engine of the vehicle, electric power may be generated using the motive power of the internal combustion engine.

The gate drive unit 17 performs a switching operation of each of the switching elements of the first power conversion unit 12 and the second power conversion unit 13 and each of the disconnectors 25, 26, 35, and 36 between ON (electrical connection) and OFF (electrical disconnection) on the basis of a control signal received from the electronic control unit 18. For example, the gate drive unit 17 performs a switching operation between ON (electrical connection) and OFF (electrical disconnection) by outputting a gate signal generated through amplification and level-shift processes for the control signal and the like to each of the switching elements of the full-bridge circuits 12a, 12b, 13a, and 13b.

The electronic control unit 18 integrally controls the operations of the power control unit 10a and the rotating electric machine 16 (M). For example, the electronic control unit 18 is a software function unit that functions when a processor such as a central processing unit (CPU) executes a predetermined program. The software function unit is an electronic control unit (ECU) including a processor such as a CPU, a read-only memory (ROM) that stores a program, a random-access memory (RAM) that temporarily stores data, and an electronic circuit such as a timer. In addition, at least a part of the electronic control unit 18 may be an integrated circuit such as a large-scale integration (LSI) circuit.

The electronic control unit 18 generates a control signal indicating a timing at which the switching elements of the first power conversion unit 12 and the second power conversion unit 13 and the disconnectors 25, 26, 35, and 36 are driven between ON (electrical connection) and OFF (electrical disconnection). The electronic control unit 18 inputs the generated control signals to the gate drive unit 17.

### (Control Operation of Electric Equipment)

In the case of a power running operation or a regenerative operation of the rotating electric machine 16 (M), the electronic control unit 18 sets the first disconnector 25 and the second disconnector 26 in the ON (electrical connection) state. The electronic control unit 18 performs a switching operation between a series connection of the α-phase coils α1 and α2 and a series connection of the β-phase coils β1 and β2 and a parallel connection of the α-phase coils α1 and α2 and a parallel connection of the β-phase coils β1 and β2 by switching the first switch 22 and the second switch 32 between ON (electrical connection) and OFF (electrical disconnection).

The electronic control unit 18, for example, performs electric current feedback control using an electric current detection value of the rotating electric machine 16 (M) and an electric current target value corresponding to a torque command value of the rotating electric machine 16 (M) and the like, and generates a control signal for issuing an instruction to drive each switching element of the first power conversion unit 12 and the second power conversion unit 13.

In the case of the power running or regenerative operation of the rotating electric machine 16 (M), electric currents flow in the same direction (in phase) with respect to the coils α1, α2, β1, and β2. The back electromotive waveforms of the coils α1, α2, β1, and β2, for example, are the same as those of a case where the number of turns of the coils α1, α2, β1, and β2 are the same on the first pole and the second pole. Even if the combination of the number of turns of the coils α1 and α2 on the first pole and the second pole of the stator core 42 and the combination of the number of turns of the coils β1 and β2 are different as in the rotating electric machine 16 (M) of the embodiment, the power running and regenerative performances are equivalent to those of the case where the number of turns is the same.

During DC charging, i.e., when the power storage device 11 is charged by an external DC power supply connected to the DC power supply connection unit 14, the electronic control unit 18 sets the first disconnector 25 and the second disconnector 26 in an ON (electrical connection) state. For example, the electronic control unit 18 causes each of the combination of the α-phase coils α1 and α2 and the first power conversion unit 12 and the combination of the β-phase coils β1 and β2 and the second power conversion unit 13 to function as a non-insulated DC-DC converter that performs a boost operation according to so-called chopper control with respect to an external DC power supply having a lower voltage than the power storage device 11.

During AC charging, i.e., when the power storage device 11 is charged using an external AC power supply connected to the AC power supply connection unit 15, the electronic control unit 18 sets the first disconnector 25 and the second disconnector 26 in an OFF (electrical disconnection) state for insulation.

The electronic control unit 18, for example, sets the α-phase-specific first coil 23 (α1) and the α-phase-specific second coil 24 (α2), which are magnetically coupled to each other with the same polarity, as a coil of a DC conversion phase (a phase) used for conversion between DC powers. The electronic control unit 18, for example, causes the combination of each of the α-phase coils α1 and α2 and the first power conversion unit 12 to function as a dual active bridge (DAB) type DC-DC converter, which is an insulated bidirectional (step-up and step-down) converter.

The electronic control unit 18, for example, sets the β-phase-specific first coil 33 (β1) and the β-phase-specific second coil 34 (β2), which are magnetically coupled to each other with the same polarity, as a coil of an AC input phase (β phase) connected to an external AC power supply. The electronic control unit 18, for example, causes a combination of each of the β-phase coils β1 and β2 and the second power conversion unit 13 to function as a so-called full-bridgeless type (or bridgeless and totem pole type) power factor correction (PFC) circuit that converts AC power into DC power. The so-called bridgeless PFC is PFC that does not include a bridge rectifier made of a plurality of diodes connected in a bridge, and the so-called totem pole PFC is PFC that includes a pair of switching elements of the same conductivity type connected in series in the same direction (totem pole connection). The electronic control unit 18, for example, controls the switching operation of each switching element in the respective full-bridge circuits 13a and 13b of the second power conversion unit 13, thereby improving the power factor of an input voltage Vac and an input current lac while rectifying the AC power received from the external AC power supply to DC power and boosting the DC power.

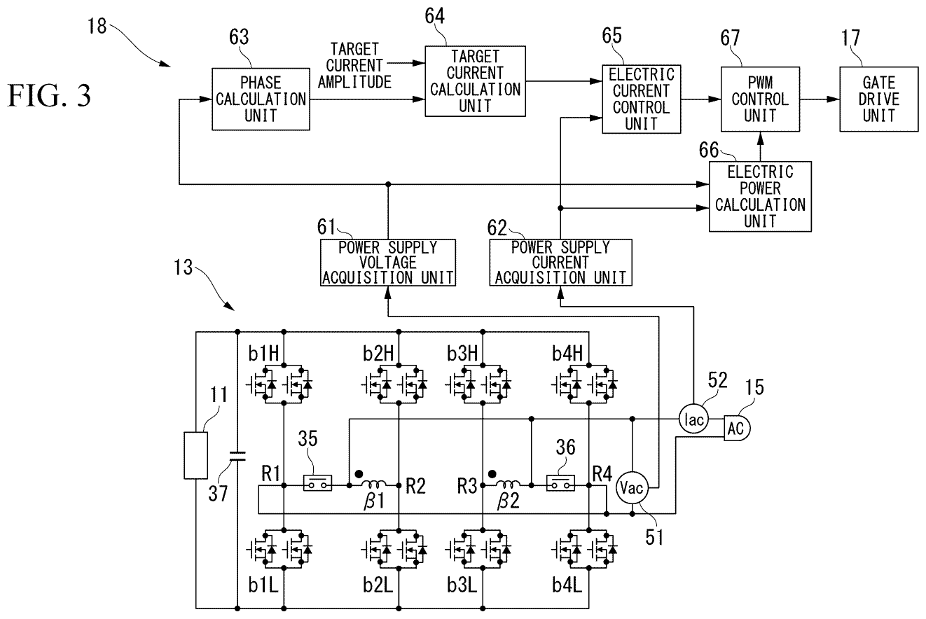

FIG. 3 is a block diagram showing a functional configuration of the electronic control unit 18 during AC charging of the electric equipment 10 according to the embodiment.

As shown in FIG. 3, the second power conversion unit 13 includes, for example, an input voltage sensor 51 that detects the input voltage Vac of the external AC power supply, and an input current sensor 52 that detects the input current Iac of the external AC power supply.

The electronic control unit 18 includes, for example, a power supply voltage acquisition unit 61, a power supply current acquisition unit 62, a phase calculation unit 63, a target current calculation unit 64, an electric current control unit 65, an electric power calculation unit 66, and a PWM control unit 67.

The power supply voltage acquisition unit 61, for example, outputs the input voltage Vac acquired from the input voltage sensor 51.

The power supply current acquisition unit 62, for example, outputs the input current lac acquired from the input current sensor 53.

The phase calculation unit 63, for example, calculates a phase of the input voltage Vac output from the power supply voltage acquisition unit 61.

The target current calculation unit 64, for example, calculates a target current synchronized with the input voltage Vac on the basis of a target current amplitude for the input current lac and a phase of the input voltage Vac output from the phase calculation unit 63.

The electric current control unit 65, for example, outputs a duty ratio of the voltage command by proportional-integral (PI) control or the like based on an electric current deviation obtained by subtracting the target current output from the target current calculation unit 64 from the input current Iac output from the power supply current acquisition unit 62. The duty ratio of the voltage command specifies a ratio of an ON-time to a switching period of paired switching elements (i.e., the switching elements of the high-side arm and the low-side arm of each phase) in a phase of each of the full-bridge circuits 13a and 13b of the second power conversion unit 13.

The electric power calculation unit 66, for example, outputs the power supply power obtained by multiplying the input voltage Vac output from the power supply voltage acquisition unit 61 and the input current Iac output from the power supply current acquisition unit 62.

The PWM control unit 67, for example, generates a control signal indicating a timing to drive each switching element in the respective full-bridge circuit 13a and 13b of the second power conversion unit 13 between ON (electrical connection) and OFF (electrical disconnection) according to a pulse width modulation operation based on the duty ratio of the voltage command output from the electric current control unit 65. The PWM control unit 67, for example, sets switching of the switching pattern according to the power supply power output from the electric power calculation unit 66. For example, the following Table 2 shows switching patterns in a parallel mode. The parallel mode is a mode in which the β-phase-specific first coil 33 (β1) and the β-phase-specific second coil 34 (β2) are connected in parallel.

TABLE 2

| | Element unit | | | | | | | |
|---|---|---|---|---|---|---|---|---|
| Mode | b1H | b1L | b2H | b2L | b3H | b3L | b4H | b4L |
| First mode | ON | OFF | ON | OFF | ON | OFF | ON | OFF |
| (Charging) | | | | | | | | |
| Second mode | ON | OFF | OFF | ON | OFF | ON | ON | OFF |
| (Discharging) | | | | | | | | |
| Third mode | OFF | ON | ON | OFF | ON | OFF | OFF | ON |
| (Discharging) | | | | | | | | |
| Fourth mode | OFF | ON | OFF | ON | OFF | ON | OFF | ON |
| (Charging) | | | | | | | | |

In the switching patterns shown in the above Table 2, the first and fourth modes are modes for charging the β-phase-specific first coil 33 (β1) and the β-phase-specific second coil 34 (β2) and the second and third modes are modes for discharging the respective β-phase coils 33 (β1) and 34 (β2).

In the above Table 2, for example, as the duty (ON ratio) of the element units b2H and b3H of the high-side arms of the second leg and the third leg in the second power conversion unit 13 decreases toward 0.5, the first mode and the fourth mode in which the β-phase coils 33 (β1) and 34 (β2) are charged increase and the second mode in which the β-phase coils 33 (β1) and 34 (β2) are discharged decreases. For example, when the duty (ON ratio) of the element units b2H and b3H of the high-side arms of the second leg and the third leg is 0.5, only the first mode and the fourth mode in which the β-phase coils 33 (β1) and 34 (β2) are charged are available. For example, as the duty (ON ratio) of the element units b2H and b3H of the high-side arms of the second leg and the third leg decreases from 0.5, the first mode and fourth mode in which the respective β-phase coils 33 (β1) and 34 (β2) are charged decrease and the third mode in which the respective β-phase coils 33 (β1) and 34 (β2) are discharged increases.

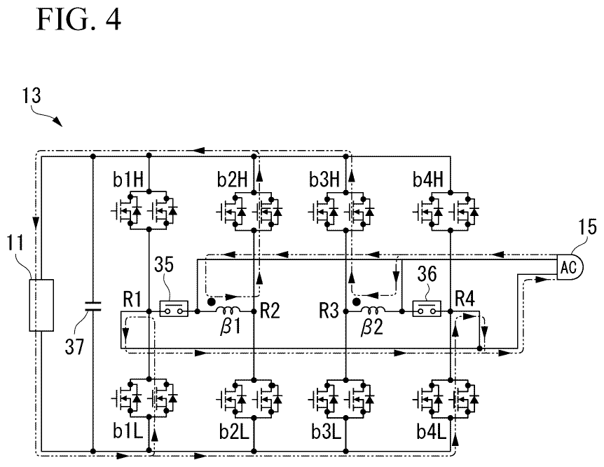

FIG. 4 is a circuit diagram showing an example of an electric current flow in the parallel mode during AC charging in the electric equipment 10 according to the embodiment. The example shown in FIG. 4 corresponds to the third mode in the above Table 2.

As shown in FIG. 4, in the case of the parallel mode during AC charging, the electronic control unit 18 sets the third disconnector 35 and the fourth disconnector 36 in the OFF (electrical disconnection) state. In the case of the parallel mode, electric currents flow from the AC power supply connection unit 15 to the coils β1 and β2, so to speak, in directions opposite to each other (phases opposite to each other). The electric currents flowing through the β-phase-specific first coil 33 (β1) and the β-phase-specific second coil 34 (β2) are opposite-phase currents that mutually weaken magnetic fluxes. A degree of weakening of the magnetic flux varies with the combination of the number of turns of the β-phase coils 33 (β1) and 34 (β2) on the first and second poles that form a pole pair (N and S poles) in the stator core 42 of the rotating electric machine 16 (M). For example, as a difference between the combinations of the number of turns on the first and second poles increases, the degree of weakening of the magnetic flux decreases. As the degree of weakening of the magnetic flux between the β-phase coils 33 (β1) and 34 (β2) decreases, the inductance of each of the β-phase coils 33 (β1) and 34 (β2), for example, increases compared to the leakage inductance due to the leakage magnetic flux when the magnetic fluxes are mutually offset. For example, in the model of the rotating electric machine 16 (M) shown in FIG. 2, the magnetic flux waveform has 4 poles as indicated by a magnetic flux line F.

As the combination of the number of turns of the respective coils β1 and β2 on the first and second poles of the stator core 42 is inverted, for example, because the magnetic flux waveforms of the coils β1 and β2 are mutually inverted and offset, the torque generated in the rotating electric machine 16 (M) during AC charging is zero. For example, when the rotor 41 and the stator core 42 of the rotating electric machine 16 (M) have 8 poles, if a current-carrying process is performed in an inverted phase with respect to the winding pattern shown in the above Table 1, the magnetic flux waveform of the stator core 42 will have 16 poles. The ratio of the number of magnetic poles of the rotor 41 and the stator core 42 is 1:2 and a magnetic circuit that generates the magnetic flux without generating torque is provided.

As described above, according to the electric equipment 10 of the embodiment, the combination of the number of turns of the respective coils β1 and β2 is different between the first pole and the second pole of the stator core 42, such that the magnetic fluxes are prevented from being mutually offset even if a current-carrying process is performed in an inverted phase during parallel connection. An inductance larger than the leakage inductance can be generated and electric current ripples and distortions can be suppressed, thereby improving charging efficiency.

Because the combination of the number of turns of the respective coils β1 and β2 on the first pole and the second pole is in an inverted corresponding relationship, the number of turns of the respective coils β1 and β2 can be made the same as each other throughout the stator core 42. Thereby, it is possible to suppress the torque generation of the rotating electric machine 16 during AC charging, and to suppress the generation of impact noise such as gear backlash noise caused by torque pulsation. The back electromotive waveforms of the respective coils β1 and β2 during power running and regeneration of the rotating electric machine 16 can be made the same as those of a case where the number of turns of the respective coils β1 and β2 on the first pole and the second pole are the same, and the power running and regeneration performances can be made equivalent.

The coils β1 and β2 are arranged in slots 43 facing each other in which the central axis O is sandwiched therebetween in the stator core 42, such that, for example, even if a current-carrying process is performed in an inverted phase during parallel connection, it is possible to generate a magnetic flux distribution that cancels out the torque on the rotor 41. By suppressing the torque generation of the rotating electric machine 16 during AC charging, the generation of impact noise such as gear backlash noise caused by torque pulsation can be suppressed.

By arranging the β-phase-specific first coil 33 (β1) in the first slot SL1 and the second slot SL2 and arranging the β-phase-specific second coil 34 (β2) in the third slot SL3 and the fourth slot SL4, the inductance can be increased and electric current ripples and distortions and the like can be further suppressed.

When the rotating electric machine 16 (M) is driven by the power storage device 11, the power control unit 10a can function as an inverter of a quad full-bridge circuit. When the power storage device 11 is charged with a DC current by an external power supply, a combination of each coil of the rotating electric machine 16 (M) and each full-bridge circuit can function as a non-insulated DC-DC converter. When the power storage device 11 is charged with an AC current by an external power supply, a combination of the respective α-phase coils 23 (α1) and 24 (α2) of the rotating electric machine 16 (M) and the first full-bridge circuit 12a and the second full-bridge circuit 12b can function as an insulated bidirectional DC-DC converter. A combination of the respective β-phase coils 33 (β1) and 34 (β2) and the third and fourth full-bridge circuits 13a and 13b can function as a rectification circuit. For example, in the case of a boost operation during AC charging, rapid charging can be performed with respect to the voltage of the power storage device 11 higher than the charging voltage by the external power supply.

### Modified Example

A modified example of the embodiment will be described below. In addition, parts identical to those in the above-described embodiment are denoted by the same reference signs and descriptions thereof will be omitted or simplified.

Although the α-phase coils α1 and α2 are arranged, like the β-phase coils β1 and β2, so that the combinations of the number of turns are different between the first pole and the second pole forming a pole pair (N and S poles) in the stator core 42 in the above-described embodiment, the present invention is not limited thereto. For example, the number of turns of the coils α1 and α2 may be the same between the first pole and the second pole.

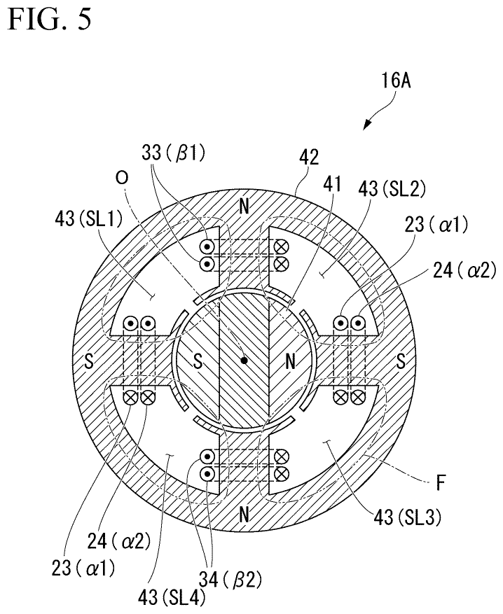

FIG. 5 is a modeled configuration diagram of a rotating electric machine 16A according to a first modified example of the embodiment.

The following table 3 shows an example of the number of turns of each of the coils α1, α2, β1, and β2 corresponding to the N and S poles in the first and second pole pairs in the rotating electric machine 16A of the first modified example shown in FIG. 5.

TABLE 3

| Magnetic pole | |
|---|---|
| First pole pair | Second pole pair |

| Coil | N pole | S pole | N pole | S pole |
|---|---|---|---|---|
| α1 | 16 | 16 | 16 | 16 |
| α2 | 16 | 16 | 16 | 16 |
| β1 | 0 | 32 | 32 | 0 |
| β2 | 32 | 0 | 0 | 32 |

As shown in FIG. 5 and the above Table 3, in the rotating electric machine 16A of the first modified example, the combinations of the number of turns of the respective coils β1 and β2 on the first and second poles that form a pole pair (N and S poles) in the stator core 42 are different and the number of turns of the respective coils α1 and α2 is the same as each other.

Although the number of turns of the β-phase-specific first coil 33 (β1) or the β-phase-specific second coil 34 (β2) is zero for each of the first and second poles that form a pole pair (N and S poles) in the stator core 42 in the above-described embodiment, the present invention is not limited thereto. For example, the β-phase-specific first coil 33 (β1) and the β-phase-specific second coil 34 (β2) may be provided for each of the first and second poles.

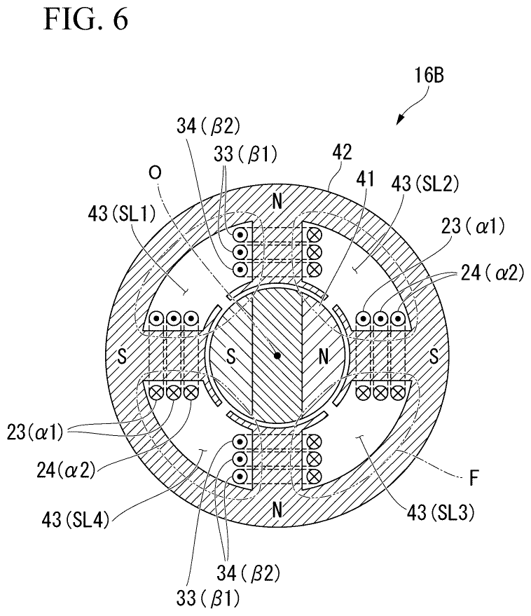

FIG. 6 is a modeled configuration diagram of a rotating electric machine 16B according to a second modified example of the embodiment. In addition, the number of turns of each of the coils α1, α2, β1, and β2 shown in FIG. 6 is a schematic example.

As shown in FIG. 6, the rotating electric machine 16B of the second modified example includes the coils α1 and α2 having different numbers of turns and the coils β1 and β2 having different numbers of turns on each of the first and second poles.

The following Table 4 shows an example of the number of turns of each of the coils α1, α2, β1, and β2 corresponding to the N and S poles in the first and second pole pairs in the rotating electric machine 16B of the second modified example shown in FIG. 6.

TABLE 4

| Magnetic pole | |
|---|---|
| First pole pair | Second pole pair |

| Coil | N pole | S pole | N pole | S pole |
|---|---|---|---|---|
| α1 | 8 | 24 | 24 | 8 |
| α2 | 24 | 8 | 8 | 24 |
| β1 | 8 | 24 | 24 | 8 |
| β2 | 24 | 8 | 8 | 24 |

As shown in the above Table 4, in the rotating electric machine 16B of the second modified example, the ratio of the number of turns of the coils β1 and β2 provided on each of the first and second poles is β1:β2=1:3 or β1:β2=3:1. In the rotating electric machine 16B of the second modified example, the coils α1 and α2 of the α phase are similar to the coils β1 and β2 of the β phase, and the ratio of the number of turns of the coils α1 and α2 provided on the first and second poles is α1:α2=1:3 or α1:α2=3:1.

In addition, in the above-described second modified example, for example, the number of turns of the coils α1 and α2 in the first pole and the second pole may be the same.

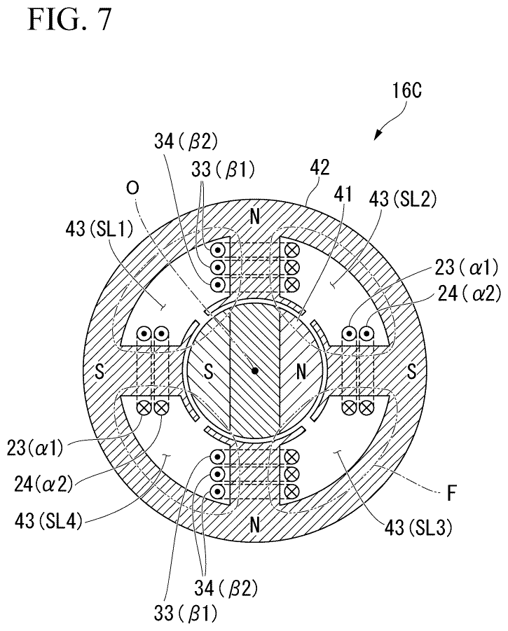

FIG. 7 is a modeled configuration diagram of a rotating electric machine 16C according to a third modified example of the embodiment. In addition, the number of turns of the coils α1, α2, β1, and β2 shown in FIG. 7 is a schematic example.

As shown in FIG. 7, the rotating electric machine 16C of the third modified example includes the coils α1 and α2 having the same number of turns and the coils β1 and β2 having different numbers of turns on each of the first and second poles.

The following Table 5 shows an example of the number of turns of each of the coils α1, α2, β1, and β2 corresponding to the N and S poles of the first and second pole pairs in the rotating electric machine 16C of the third modified example shown in FIG. 7.

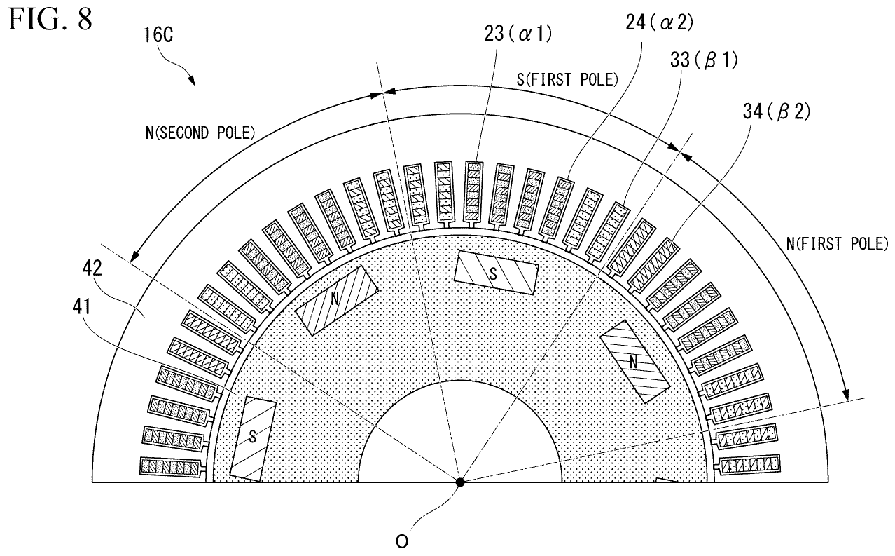

FIG. 8 is a configuration diagram showing an example of distributed winding of the rotating electric machine 16C in the third modified example of the embodiment in correspondence with the following Table 5.

TABLE 5

| Magnetic pole | |
|---|---|
| First pole pair | Second pole pair |

| Coil | N pole | S pole | N pole | S pole |
|---|---|---|---|---|
| α1 | 16 | 16 | 16 | 16 |
| α2 | 16 | 16 | 16 | 16 |
| β1 | 8 | 24 | 24 | 8 |
| β2 | 24 | 8 | 8 | 24 |

As shown in FIG. 8 and the above Table 5, in the rotating electric machine 16C of the third modified example, the ratio of the number of turns of the coils β1 and β2 of the first and second poles is β1:β2=1:3 or β1:β2=3:1. The coils α1 and α2 of the first and second poles have the same number of turns. For example, when the rotor 41 and the stator core 42 of the rotating electric machine 16C of the third modified example have 8 poles, if a current-carrying process is performed in an inverted phase with respect to the winding pattern shown in the above Table 5, the magnetic flux waveform of the stator core 42 has 4 poles. The ratio of the number of magnetic poles of the rotor 41 and the stator core 42 is 2:1, a magnetic circuit that generates a magnetic flux without generating torque is provided.

Although the β-phase-specific first coil 33 (β1) and the β-phase-specific second coil 34 (β2) are magnetically coupled to each other with the same polarity in the above embodiment, the present invention is not limited thereto. The β-phase-specific first coil 33 (β1) and the β-phase-specific second coil 34 (β2) may be magnetically coupled to each other with opposite polarity. In this case, for example, a disconnector connected between one end of the β-phase-specific first coil 33 (β1) and the midpoint R2 of the second phase of the third full-bridge circuit 13a or a disconnector connected between one end of the β-phase-specific second coil 34 (β2) and the midpoint R3 of the third phase of the fourth full-bridge circuit 13b may be provided. In short, in the state of the parallel mode state during AC charging, it is only necessary for an electrical current to flow in a flow direction such that the magnetic fluxes of the β-phase-specific first coil 33 (β1) and the β-phase-specific second coil 34 (β2) weaken each other in accordance with the polarity of the magnetic coupling therebetween.

Although an electric current flows from the external AC power supply to the β-phase-specific first coil 33 (β1) and the β-phase-specific second coil 34 (β2) during AC charging in the above embodiment, the present invention is not limited thereto. For example, at least one of a disconnector that switches the connection between the AC power supply connection unit 15 and the β-phase-specific first coil 33 (β1) between ON (electrical connection) and OFF (electrical disconnection) and a disconnector that switches the connection between the AC power supply connection unit 15 and the β-phase-specific second coil 34 (β2) between ON (electrical connection) and OFF (electrical disconnection) may be provided. In this case, a setting may be made so that an electric current flows only through the β-phase-specific first coil 33 (β1) or the β-phase-specific second coil 34 (β2).

Although the DC power supply connection unit 14 is connected to the negative electrode of the second power conversion unit 13 and the midpoint of each of the first switch 22 and the second switch 32 (i.e., between the two transistors connected in anti-series) as a parallel pattern in the above-described embodiment, the present invention is not limited thereto. For example, the DC power supply connection unit 14 may be connected to the negative electrode of the second power conversion unit 13, the midpoint Q4 of the first power conversion unit 12, and the midpoint R4 of the second power conversion unit 13 as a series pattern. For example, the DC power supply connection unit 14 may be connected to the negative electrode of the second power conversion unit 13, the midpoints Q2 and Q4 of the first power conversion unit 12, and the midpoints R2 and R4 of the second power conversion unit 13 as another parallel pattern.

In the above-described embodiment, the functional configuration of the electronic control unit 18 during AC charging of the electric equipment 10 shown in FIG. 3 may not require the acquisition of the phase of the input voltage Vac of the external AC power supply. For example, an output voltage sensor that detects an output voltage Vo across both ends (between the positive and negative electrodes) of the capacitor 37 may be provided, and a voltage control unit that outputs an electric current amplitude target value of the input current Iac of the external AC power supply may be provided according to proportional-integral (PI) control or the like based on the output voltage Vo acquired from the output voltage sensor and a target voltage.

While embodiments of the present invention have been described, these embodiments have been presented by way of example only, and are not intended to limit the scope of the inventions. These embodiments may be embodied in a variety of other forms. Various omissions, substitutions, and modifications may be made without departing from the spirit of the inventions. The inventions described in the accompanying claims and their equivalents are intended to cover such embodiments or modified examples as would fall within the scope and spirit of the inventions.

What is claimed is:

1. An electric equipment comprising:
a power storage device;
a rotating electric machine having a rotor and a plurality of coils;
an electric power control unit connected to the rotating electric machine and the power storage device and configured to control electric power transmission and reception of each of the power storage device and the rotating electric machine; and
an alternating current (AC) power supply connection member configured to connect the rotating electric machine and an external AC power supply,
wherein the electric power control unit includes a first full-bridge circuit connected to both ends of a first coil and a second full-bridge circuit connected to both ends of a second coil with respect to the first coil and the second coil forming a predetermined phase connected to the AC power supply connection member among the plurality of coils, and
wherein the rotating electric machine includes a stator core having slots in which the first coil and the second coil having a different combination of the number of turns in a first pole and a second pole forming a pole pair are arranged.

2. The electric equipment according to claim 1, wherein the first coil and the second coil are arranged in the slots facing each other in a state in which a central axis is sandwiched therebetween in the stator core.

3. The electric equipment according to claim 2, wherein the first coil and the second coil are arranged in a first slot and a second slot, respectively, with respect to the first slot and the second slot that are the slots facing each other in the state in which the central axis is sandwiched therebetween in the stator core.

4. The electric equipment according to claim 1, wherein a combination of the number of turns of the first coil and the second coil in the first pole and the second pole is identical for all pole pairs of the stator core.

5. The electric equipment according to claim 4, wherein the predetermined phase is an AC input phase for converting an input of AC power into an output of direct current (DC) power.

6. The electric equipment according to claim 5, wherein the electric power control unit includes
a first disconnector connected between an end of the first coil and the first full-bridge circuit;
a second disconnector connected between an end of the second coil and the second full-bridge circuit;
a third full-bridge circuit connected to both ends of a third coil and a fourth full-bridge circuit connected to both ends of a fourth coil with respect to the third coil and the fourth coil forming a DC conversion phase for performing conversion between DC powers among the plurality of coils;
a third disconnector connected between positive poles of the third full-bridge circuit and the fourth full-bridge circuit; and
a fourth disconnector connected between negative poles of the third full-bridge circuit and the fourth full-bridge circuit.
